(19) United States
(12) Patent Application Publication
(10) Pub. No.: US 2012/0214936 A1
(43) Pub. Date: Aug. 23, 2012

(54) OPTICAL PRESSURE-SENSITIVE ADHESIVE SHEET

(75) Inventors: Masato FUJITA, Osaka (JP); Hiroaki KISHIOKA, Osaka (JP); Hiroaki FUMOTO, Osaka (JP); Masatomo NATSUI, Osaka (JP)

(73) Assignee: NITTO DENKO CORPORATION, Osaka (JP)

(21) Appl. No.: 13/398,355

(22) Filed: Feb. 16, 2012

(30) Foreign Application Priority Data
Feb. 17, 2011 (JP) 2011-032493

(51) Int. Cl. C09J 139/06

(52) U.S. Cl. 524/548

(57) ABSTRACT

The present invention provides an optical pressure-sensitive adhesive sheet which has low relative dielectric constant, does not cause white turbidity by humidification, and is excellent in corrosion resistance. The present invention relates to an optical pressure-sensitive adhesive sheet, comprising: a pressure-sensitive adhesive layer in which a relative dielectric constant at a frequency of 100 kHz is 4 or less, and a moisture ratio after storage under an environment of 60° C. and 95% RH for 120 hours is 0.65 wt % or more. The optical pressure-sensitive adhesive sheet preferably has a total light transmittance of 90% or more and a haze of 3% or less.

### BACKGROUND OF THE INVENTION

1. Technical Field

The present invention relates to an optical pressure-sensitive adhesive sheet. More particularly, the present invention relates to an optical pressure-sensitive adhesive sheet used in lamination of an optical member, manufacture of an optical product, or the like.

2. Background Art

Recently, in various fields, display devices such as a liquid crystal display (LCD) or an input device such as a touch panel, which is used by combining with the display device has been widely used. In manufacturing of the display device or the input device, a transparent pressure-sensitive adhesive sheet (pressure-sensitive adhesive tape) is used for laminating an optical member. For example, the transparent pressure-sensitive adhesive sheet is used for laminating the touch panel and various display devices or other optical members (e.g., a protective plate) (for example, see Patent Documents 1 to 3).

As the application of the display device or input device is expanded, a pressure-sensitive adhesive sheet used in these devices requires to sufficiently exhibit characteristics as the pressure-sensitive adhesive sheet under various environments. For example, like a cellular phone having a waterproof function, in the pressure-sensitive adhesive sheet used in products used even under humidified conditions, it is required that white turbidity should not occur, an appearance of the display device or input device should not be degraded, and visibility of a display unit mounted in the display device or input device should not be decreased, due to humidification.

For example, like an electrostatic capacity type touch panel (for example, an electrostatic capacity type touch panel having a laminated structure of cover glass/pressure-sensitive adhesive sheet/ITO film/PET film/pressure-sensitive adhesive sheet/ITO film/PET film), recently in the pressure-sensitive adhesive sheet used in products in which thinning is required, there is a need for low relative dielectric constant such that the sheet has a predetermined capacitance, even the sheet is thin.

In the pressure-sensitive adhesive sheet used in the display device or input device, in order not to cause breakdown or malfunction in the display device or input device and in order not to degrade an appearance of the display device or input device, it is required that corrosion should not occur in an adherend.
Patent Document 1: JP 2003-238915 A
Patent Document 2: JP 2003-342542 A
Patent Document 3: JP 2004-231723 A

### SUMMARY OF THE INVENTION

Thus, the present invention has been made in an effort to provide an optical pressure-sensitive adhesive sheet having low relative dielectric constant, in which white turbidity is not caused by humidification.

Further, the present invention has been made in an effort to provide a pressure-sensitive adhesive sheet having excellent corrosion resistance.

Accordingly, the present inventors have studied in order to solve the problems. As a result, the inventors have found that a pressure-sensitive adhesive sheet having low relative dielectric constant, in which white turbidity does not occur by humidification, can be obtained by using the pressure-sensitive adhesive layer of the pressure-sensitive sheet in which a relative dielectric constant is small, and a moisture ratio after storage under an environment of 60° C. and 95% RH for 120 hours is a predetermined value or more. The present invention has been achieved based on these findings.

That is, the present invention provides an optical pressure-sensitive adhesive sheet, comprising: a pressure-sensitive adhesive layer in which a relative dielectric constant at a frequency of 100 kHz is 4 or less, and a moisture ratio after storage under an environment of 60° C. and 95% RH for 120 hours is 0.65 wt % or more.

In addition, the optical pressure-sensitive adhesive sheet preferably has a total light transmittance of 90% or more and a haze of 3% or less.

In addition, in the optical pressure-sensitive adhesive sheet, the pressure-sensitive adhesive layer preferably comprises an acrylic polymer comprising, as a monomer component, at least one monomer selected from the group consisting of alkyl ester acrylate having a linear or branched alkyl group having 6 to 10 carbon atoms, alkyl ester methacrylate having a linear or branched alkyl group having 1 to 10 carbon atoms, ester (meth)acrylate having an alicyclic hydrocarbon group and a nitrogen-containing monomer, in which a ratio of the monomer component is 60 wt % or more based on a total amount (100 wt %) of monomer components constituting the acrylic polymer.

In addition, in the optical pressure-sensitive adhesive sheet, the ester (meth)acrylate having a alicyclic hydrocarbon group is preferably at least one monomer selected from the group consisting of cyclohexyl (meth)acrylate and isobornyl (meth)acrylate.

In addition, in the optical pressure-sensitive adhesive sheet, the nitrogen-containing monomer is preferably at least one monomer selected from the group consisting of (meth)acryloyl morpholine and N-vinylpyrrolidone.

In addition, in the optical pressure-sensitive adhesive sheet, a total amount of an acrylic acid ion and methacrylic acid ion which are extracted with pure water under a condition of 100° C. and 45 min, which is measured by an ion chromatograph method, is preferably 300 ng/cm² or less per unit area of the pressure-sensitive adhesive layer.

In addition, the present invention provides an optical pressure-sensitive adhesive sheet comprising: a pressure-sensitive adhesive layer in which a relative dielectric constant at a frequency of 100 kHz is 4 or less, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

Since the optical pressure-sensitive adhesive sheet of the present invention has the above constitution, the optical pressure-sensitive adhesive sheet has low relative dielectric constant in which white turbidity is not caused by humidification.

### BRIEF DESCRIPTION OF THE DRAWINGS

FIG. 1 is a schematic view showing an example of an electrostatic capacity type touch panel in which the optical pressure-sensitive adhesive sheet of the present invention is used.

FIG. 2 is a schematic view (plan view) showing a sample for resistance measurement used in evaluating corrosion resistance.

FIG. 3 is a schematic view (A-A cross-sectional view of FIG. 2) showing a sample for resistance measurement used in evaluating corrosion resistance.

### DETAILED DESCRIPTION OF THE INVENTION

The optical pressure-sensitive adhesive sheet of the present invention at least includes a pressure-sensitive adhesive layer, in which a relative dielectric constant at a frequency of 100 kHz is 4 or less, and a moisture ratio after storage under an environment of 60° C. and 95% RH for 120 hours is 0.65 wt % or more. Hereinafter, the pressure-sensitive adhesive layer, in which a relative dielectric constant at a frequency of 100 kHz is 4 or less, and a moisture ratio after storage under an environment of 60° C. and 95% RH for 120 hours is 0.65 wt % or more” is also called as the “pressure-sensitive adhesive layer of the present invention” in some cases.

In the optical pressure-sensitive adhesive sheet of the present invention, the “pressure-sensitive adhesive sheet” also includes a tape shaped sheet, that is, a “pressure-sensitive adhesive tape”. A surface of the pressure-sensitive adhesive layer in the optical pressure-sensitive adhesive sheet of the present invention may also be called a “pressure-sensitive adhesive surface” in some cases.

The optical pressure-sensitive adhesive sheet of the present invention may be a double-sided pressure-sensitive adhesive sheet having pressure-sensitive adhesive surfaces on both surfaces of the sheet, or a single-sided pressure-sensitive adhesive sheet having a pressure-sensitive surface on only one surface of the sheet. Among them, from the viewpoint of laminating two members, the optical pressure-sensitive adhesive sheet of the present invention is preferably the double-sided pressure-sensitive adhesive sheet.

The optical pressure-sensitive adhesive sheet of the present invention may be so-called a “substrateless type pressure-sensitive adhesive sheet” (hereinafter, referred to as “substrateless pressure-sensitive adhesive sheet” in some cases) that does not have a substrate (substrate layer), or a substrate type pressure-sensitive adhesive sheet (hereinafter, referred to as “pressure-sensitive adhesive sheet with substrate” in some cases). When the optical pressure-sensitive adhesive sheet of the present invention is a substrateless type pressure-sensitive adhesive sheet, specific constitutions thereof may be, for example, a double-sided pressure-sensitive adhesive sheet consisting of pressure-sensitive adhesive layers of the present invention, a double-sided pressure-sensitive adhesive sheet including the pressure-sensitive adhesive layer of the present invention and a pressure-sensitive adhesive layer other than the pressure-sensitive adhesive layer of the present invention (hereinafter, also referred to as “other pressure-sensitive adhesive layer” in some cases). When the optical pressure-sensitive adhesive sheet of the present invention is a pressure-sensitive adhesive sheet with substrate, specific constitutions thereof may be, for example, a single-sided pressure-sensitive adhesive sheet including a substrate and the pressure-sensitive adhesive layer of the present invention on one side of the substrate, a double-sided pressure-sensitive adhesive sheet including a substrate and the pressure-sensitive adhesive layers of the present invention on both sides of the substrate, a double-sided pressure-sensitive adhesive sheet including a substrate and the pressure-sensitive adhesive layer of the present invention on one side of the substrate and other pressure-sensitive adhesive layer on the other side of the substrate. Among them, from the viewpoint of making thinner or improving optical properties such as transparency, the substrateless type pressure-sensitive adhesive sheet is preferable, and the double-sided pressure-sensitive adhesive sheet consisting of the pressure-sensitive adhesive layer of the present invention is more preferable.

[Pressure-Sensitive Adhesive Layer of the Present Invention]

In the optical pressure-sensitive adhesive sheet of the present invention, the pressure-sensitive adhesive layer of the present invention is essential, and is appropriately used for laminating optical members.

The pressure-sensitive adhesive layer of the present invention has a relative dielectric constant at a frequency of 100 kHz of 4 or less, preferably 3.8 or less, and more preferably 3.5 or less. When the relative dielectric constant of the pressure-sensitive adhesive layer is more than 4, the layer is thin and it is difficult to obtain a pressure-sensitive adhesive layer with low relative dielectric constant. The relative dielectric constant is measured in accordance with JIS K 6911.

In the pressure-sensitive adhesive layer of the present invention, the moisture ratio after storage under the environment of 60° C. and 95% RH for 120 hours is 0.65 wt % or more (for example, 0.65 to 5.0 wt %), preferably 0.65 to 3.0 wt %, and more preferably 0.75 to 3.0 wt %.

The white turbidity of a pressure-sensitive adhesive sheet caused by humidification appears to be a phenomenon that is caused by placing the pressure-sensitive adhesive sheet under high temperature and high humidity environment, which leads that the pressure-sensitive adhesive layer absorbs moisture and the absorbed moisture is condensed. In the optical pressure-sensitive adhesive sheet of the present invention, the moisture ratio of the pressure-sensitive adhesive layer of the present invention (moisture ratio after storage under the environment of 60° C. and 95% RH for 120 hours) is controlled to 0.65 wt % or more. Accordingly, for example, even in the case where the environment under which the pressure-sensitive adhesive sheet is used is largely changed (for example, a change from a high temperature and high humidity environment to a room temperature environment), the absorbed moisture is not easily condensed due to high water absorbability of the pressure-sensitive adhesive layer, and as a result, it is assumed that white turbidity caused by humidification is suppressed.

The moisture ratio of the pressure-sensitive adhesive layer is a value that is obtained by storing the pressure-sensitive adhesive layer of the present invention under the environment of 60° C. and 95% RH for 120 hours, and subsequently measuring immediately after (for example, about 0 to 10 min after taking out) taking out the layer under a room temperature environment (23° C. and 50% RH). Specifically, the moisture ratio of the pressure-sensitive adhesive layer of the present invention after storage under the environment of 60° C. and 95% RH for 120 hours can be, for example, measured by a method that is disclosed in the following section of “(Method for measuring moisture ratio)”.

[Method for Measuring Moisture Ratio]

(Preparation of Sample and Measurement of Moisture Ratio)

About 0.2 g of the pressure-sensitive adhesive layer is taken out from the pressure-sensitive adhesive sheet to use as a sample.

After the sample is stored under the environment of 60° C. and 95% RH for 120 hours, the sample is weighed, and subsequently put it in the following heating vaporization apparatus, and gas generated when heating at 150° C. is introduced into a titration cell of the following coulometric titration moisture measuring apparatus. By the coulometric titration moisture measuring apparatus, the moisture content (μg) of the sample is measured under the following measuring condition, the moisture content per 1 g of the pressure-sensitive adhesive layer of the present invention after storage under the environment of 60° C. and 95% RH for 120 hours is obtained, and the moisture ratio (wt %) of the pressure-sensitive adhesive layer is calculated. The number of measurements (n number) is not limited, but is preferably twice.

(Analysis Apparatus)

Heating vaporization apparatus: “VA-06 type” manufactured by Mitsubishi Chemical Corp.

Coulometric titration moisture measuring apparatus: “CA-06 type” manufactured by Mitsubishi Chemical Corp.

(Measuring Condition)

Method: heating vaporization method/150° C. heating

Anode solution: Aquamicron AKX

Cathode solution: Aquamicron CXU

The total light transmittance of the pressure-sensitive adhesive layer of the present invention in a visible light wavelength region (in accordance with JIS K7361) is not particularly limited, but is preferably 90% or more, and more preferably 91% or more from the standpoint of improving the transparency of the optical pressure-sensitive adhesive sheet of the present invention. The haze of the pressure-sensitive adhesive layer of the present invention (in accordance with JIS K7136) is not particularly limited, but is preferably 3% or less, and more preferably 1.0% or less from the standpoint of improving the transparency of the optical pressure-sensitive adhesive sheet of the present invention.

The pressure-sensitive adhesive layer of the present invention is not particularly limited so long as the relative dielectric constant at a frequency of 100 kHz and the moisture ratio after storage under the environment of 60° C. and 95% RH for 120 hours are in the above range. The kind of a pressure-sensitive adhesive for forming the pressure-sensitive adhesive layer of the present invention is not particularly limited, but examples thereof include, for example, an acrylic pressure-sensitive adhesive, a rubber-based pressure-sensitive adhesive, a vinylalkylether-based pressure-sensitive adhesive, a silicon-based pressure-sensitive adhesive, a polyester-based pressure-sensitive adhesive, a polyamide-based pressure-sensitive adhesive, an urethane-based pressure-sensitive adhesive, a fluorine-based pressure-sensitive adhesive and an epoxy-based pressure-sensitive adhesive. These pressure-sensitive adhesives may be used either alone or in combination of two or more thereof.

The pressure-sensitive adhesive for forming the pressure-sensitive adhesive layer of the present invention may be any type of a pressure-sensitive adhesive. For example, examples of the pressure-sensitive adhesive for forming the pressure-sensitive adhesive layer of the present invention include an emulsion type pressure-sensitive adhesive, a solvent type (solution type) pressure-sensitive adhesive, an active energy-ray curable pressure-sensitive adhesive and a hot melt type pressure-sensitive adhesive. Among them, as the pressure-sensitive adhesives for forming the pressure-sensitive adhesive layer of the present invention, the solvent type pressure-sensitive adhesive or the active energy-ray curable pressure-sensitive adhesive is preferred from the viewpoint of productivity.

Among the pressure-sensitive adhesives for forming the pressure-sensitive adhesive layer of the present invention, the acrylic pressure-sensitive adhesive is preferred from the viewpoint of weather resistance, cost and designability of the pressure-sensitive adhesive. That is, the pressure-sensitive adhesive layer of the present invention is preferably an acrylic pressure-sensitive adhesive layer that includes the acrylic polymer as a main component. The content of the acrylic polymer in the pressure-sensitive adhesive layer of the present invention is not particularly limited, but is preferably 85 wt % or more (for example, 85 wt % to 100 wt %), more preferably 90 wt % or more (for example, 90 wt % to 100 wt %), and even more preferably 95 wt % or more (for example, 95 wt % to 100 wt %), based on the total amount of the pressure-sensitive adhesive layer (100 wt %).

The acrylic pressure-sensitive adhesive layer (pressure-sensitive adhesive layer of the present invention) is formed from an acrylic pressure-sensitive adhesive composition. The acrylic pressure-sensitive adhesive composition is not particularly limited, but examples of the composition thereof include an acrylic pressure-sensitive adhesive composition that includes an acrylic polymer as an essential component, or an acrylic pressure-sensitive adhesive composition that includes, as an essential component, a mixture of monomers constituting the acrylic polymer (referred to as a “monomer mixture” in some cases) or partially polymerized product thereof. As the former acrylic pressure-sensitive adhesive composition, examples thereof include a so-called solvent type pressure-sensitive adhesive composition. As the latter acrylic pressure-sensitive adhesive composition, examples thereof include a so-called active energy-ray curable pressure-sensitive adhesive composition. The above pressure-sensitive adhesive composition may include additives, if necessary.

The “pressure-sensitive adhesive composition” includes the meaning of the “composition for forming the pressure-sensitive adhesive layer”. The “monomer mixture” means a mixture consisting of monomer components constituting the polymer. The “partially polymerized product” means a composition in which one or two or more components of the components of the monomer mixture are partially polymerized.

The acrylic polymer is a polymer composed of (formed from) the acrylic monomer as an essential monomer component. The acrylic polymer is not particularly limited, but is preferably a polymer at least including, as monomer components, alkyl ester (meth)acrylate having a linear or branched alkyl group and a polar group-containing monomer. The monomer component constituting the acrylic polymer may include other copolymerizable monomer(s). The “(meth)acryl” means “acryl” and/or “methacryl” (any one or both of “acryl” and “methacryl”), and the same applies to the following.

The alkyl ester (meth)acrylate having the linear or branched alkyl group may include, for example, alkyl ester (meth)acrylate having 1 to 20 carbon atoms such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate and eicosyl (meth)acrylate. The alkyl ester (meth)acrylate may be used alone or in combination of two or more thereof.

As the polar group-containing monomer, examples thereof include a hydroxyl group-containing monomer such as 2-hydroxyethyl (meth)acrylate, 3-hydroxypropyl (meth)acrylate, 4-hydroxybutyl (meth)acrylate, 6-hydroxyhexyl (meth)acrylate, vinyl alcohol and allyl alcohol; a nitrogen-containing monomer; an epoxy group-containing monomer such as glycidyl (meth)acrylate and methyl glycidyl (meth)acrylate; a sulfonate group-containing monomer such as sodium vinylsulfonate; a phosphate group-containing monomer such as 2-hydroxyethylacryloyl phosphate. The polar group-containing monomer may be used either alone or in combination of two or more thereof.

As the nitrogen-containing monomer, examples thereof include an amide group-containing monomer such as (meth)acrylamide, N,N-dimethyl (meth)acrylamide, N-methylol (meth)acrylamide, N-methoxymethyl (meth)acrylamide, N-butoxymethyl (meth)acrylamide and N-hydroxyethyl (meth)acrylamide; a monomer containing a nitrogen-containing hetero ring such as a monomer having a nitrogen-containing hetero ring and an N-vinyl group (a vinyl-based monomer containing a nitrogen-containing hetero ring) (for example, N-vinyl-2-pyrrolidone, N-vinyl-2-piperidone, N-vinyl-2-caprolactam, N-vinylpiperazine, N-vinylpyrrole and N-vinylimidazole) or a monomer having a nitrogen-containing hetero ring and a (meth)acryloyl group (a (meth)acrylic monomer containing a nitrogen-containing hetero ring) (for example, (meth)acryloyl morpholine); an amino group-containing monomer such as aminoethyl (meth)acrylate, dimethylaminoethyl (meth)acrylate and t-butylaminoethyl (meth)acrylate; a cyano group-containing monomer such as acrylonitrile and methacrylonitrile; an imide group-containing monomer such as cyclohexylmaleimide and isopropylmaleimide; an isocyanate group-containing monomer such as 2-methacryloyloxyethyl isocyanate.

As the other copolymerizable monomer, a polyfunctional monomer may be used. As the polyfunctional monomer, examples thereof include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxyacrylate, polyester acrylate and urethane acrylate.

As the other copolymerizable monomer other than the polyfunctional monomer, examples thereof include (meth)acrylate other than the above described alkylester (meth)acrylate, polar group-containing monomer, and functional monomer, such as (meth)acrylate having an alicyclic hydrocarbon group such as cyclopentyl (meth)acrylate, cyclohexyl (meth)acrylate and isobornyl (meth)acrylate, and (meth)acrylate having an aromatic hydrocarbon group such as phenyl(meth)acrylate, phenoxyethyl(meth)acrylate and benzyl(meth)acrylate; vinyl esters such as vinyl acetate and vinyl propionate; aromatic vinyl compounds such as styrene and vinyl toluene; olefins or dienes such as ethylene, butadiene, isoprene and isobutylene; vinyl ethers such as vinylalkyl ether; and vinyl chloride.

The other copolymerizable monomer such as a polyfunctional monomer or ester (meth)acrylate having an alicyclic hydrocarbon group may be used either alone or in combination of two or more thereof.

The acrylic pressure-sensitive adhesive layer preferably includes an acrylic polymer including, as essential monomer components, alkyl ester acrylate having a linear or branched alkyl group having 6 to 10 carbon atoms, in particular, 2-ethylhexyl acrylate (2-EHA) and isooctyl acrylate (IOA), in that the relative dielectric constant of the pressure-sensitive adhesive layer can be decreased, in that Tg (glass transition temperature) of the pressure-sensitive adhesive layer can be decreased by controlling the Tg of the pressure-sensitive adhesive layer, and in that the step absorbability of the pressure-sensitive adhesive layer can be increased by increasing the ratio of the essential monomer components with respect to the entire monomer components constituting the pressure-sensitive adhesive layer.

The acrylic pressure-sensitive adhesive layer preferably includes an acrylic polymer including, as an essential monomer component, alkyl ester (meth)acrylate having a linear or branched alkyl group having 1 to 10 carbon atoms, in particular, methyl methacrylate (MMA), in that the relative dielectric constant of the pressure-sensitive adhesive layer can be decreased, and in that the durability of the pressure-sensitive adhesive layer can be improved. If the acrylic pressure-sensitive adhesive layer includes an acrylic polymer including, as an essential monomer component, methyl methacrylate (MMA), adhesion property to polymethyl methacrylate resin (PMMA) can be further improved.

The acrylic pressure-sensitive adhesive layer more preferably includes an acrylic polymer including, as essential monomer components, alkyl ester acrylate having the linear or branched alkyl group having 6 to 10 carbon atoms and alkyl ester methacrylate having the linear or branched alkyl group having 1 to 10 carbon atoms, in that the relative dielectric constant of the pressure-sensitive adhesive layer can be decreased.

The acrylic pressure-sensitive adhesive layer preferably includes an acrylic polymer including, as essential monomer components, the nitrogen-containing monomer (preferably, the monomer containing a nitrogen-containing hetero ring, and more preferably, at least one monomer selected from the group consisting of (meth)acryloyl morpholine and N-vinylpyrrolidone), in that the relative dielectric constant of the pressure-sensitive adhesive layer can be decreased, and the cohesion force of the pressure-sensitive adhesive layer can be improved, thereby increasing the adhesion property of the pressure-sensitive adhesive layer to the adherend, and in that white turbidity of the pressure-sensitive adhesive layer, caused by humidification, can be further suppressed.

The acrylic pressure-sensitive adhesive layer preferably includes an acrylic polymer including, as essential monomer components, ester (meth)acrylate having an alicyclic hydrocarbon group, in particular, at least one monomer selected from the group consisting of cyclohexyl (meth)acrylate and isobornyl (meth)acrylate, in that the relative dielectric constant of the pressure-sensitive adhesive layer can be decreased, and Tg of the pressure-sensitive adhesive layer can be increased, thereby improving the durability of the pressure-sensitive adhesive layer.

In particular, the acrylic pressure-sensitive adhesive layer preferably includes an acrylic polymer including, as essential monomer components, at least one monomer selected from the group consisting of a nitrogen-containing monomer and ester (meth)acrylate having an alicyclic hydrocarbon group, in that a pressure-sensitive adhesive layer with low relative dielectric constant is obtained.

The acrylic pressure-sensitive adhesive layer preferably includes an acrylic polymer including, as a monomer component, at least one monomer selected from the group consisting of the alkyl ester acrylate having the linear or branched alkyl group having 6 to 10 carbon atoms, the alkyl ester methacrylate having the linear or branched alkyl group having 1 to 10 carbon atoms, the ester (meth)acrylate having an alicyclic hydrocarbon group and the nitrogen-containing monomer, in an amount of 60 wt % or more (preferably, 70 wt % or more) based on the total amount (100 wt %) of monomer components constituting the polymer, in that the relative dielectric constant of the pressure-sensitive adhesive layer is decreased.

The acrylic pressure-sensitive adhesive layer preferably includes a hydroxyl group-containing monomer (in particular, an hydroxyl group-containing ester (meth)acrylate), in that the moisture ratio of the pressure-sensitive adhesive layer can be increased, thereby further suppressing white turbidity of the pressure-sensitive adhesive layer, caused by humidification.

The content of the hydroxyl group-containing monomer (in particular, hydroxyl group-containing (meth)acrylate) is not particularly limited, but for example, is preferably 10 to 25 wt %, more preferably 10 to 22 wt %, and more preferably 12 to 22 wt % based on the total amount (100 wt %) of the monomer components constituting the acrylic polymer. By setting the content to 10 wt % or more, the moisture ratio of the pressure-sensitive adhesive layer is increased, and white turbidity is suppressed. On the other hand, by setting the content to 25 wt % or less, the moisture ratio under high humidity is prevented from excessively increasing, and it is possible to prevent a change in dielectricity from being excessively increased in a normal state and at high humidity. In the case where the change in dielectricity is excessively increased in a normal state and at high humidity, for example, a touch panel may easily have operation failure.

In the acrylic polymer included in the acrylic pressure-sensitive adhesive layer, it is preferred that a carboxyl group-containing monomer (in particular, (meth)acrylic acid) as a monomer component is either used in an extremely small amount or not used. This is because unreacted carboxylic group-containing monomers (in particular, unreacted (meth)acrylic acid) which are responsible for causing corrosion should be prevented from remaining on a pressure-sensitive adhesive layer to be formed. Specifically, for example, the content of the carboxylic group-containing monomer is preferably less than 5 wt % (for example, 0 wt % or more and less than 5 wt %), more preferably 2 wt % or less (for example, 0 wt % to 2 wt %), and even more preferably 0.5 wt % or less (for example, 0 wt % to 0.5 wt %) based on the total amount (100 wt %) of the monomer components constituting the acrylic polymer. By setting the content to less than 5 wt %, corrosion resistance of a metal thin film or metal oxide thin film is improved.

As the carboxylic group-containing monomer, examples thereof include (meth)acrylic acid, itaconic acid, maleic acid, fumaric acid, crotonic acid and isocrotonic acid. Further, acid anhydride of the carboxylic group-containing monomer (for example, the acid anhydride-containing monomer such as maleic anhydride and itaconic anhydride) is included as the carboxylic group-containing monomer. The carboxylic group-containing monomer may be used either alone or in combination of two or more thereof.

As the pressure-sensitive adhesive layer of the pressure-sensitive adhesive sheet in that an acrylic pressure-sensitive adhesive layer with low relative dielectric constant and a high moisture ratio is obtained, an appropriate aspect of a monomer component constituting the acrylic polymer may include, for example, the following aspect.

(a) An aspect that at least includes, as monomer components, alkyl ester acrylate having a linear or branched alkyl group having 6 to 10 carbon atoms; at least one monomer selected from the group consisting of a nitrogen-containing monomer and ester (meth)acrylate having an alicyclic hydrocarbon group; alkyl ester methacrylate having a linear or branched alkyl group having 1 to 10 carbon atoms; and a hydroxyl group-containing monomer, wherein the content of the alkyl ester acrylate having a linear or branched alkyl group having 6 to 10 carbon atoms is 45 wt % to 55 wt %, the total content of the at least one monomer selected from the group consisting of the nitrogen group-containing monomer and the ester (meth)acrylate having an alicyclic hydrocarbon group is 10 wt % to 25 wt %, the content of the alkyl ester methacrylate having a linear or branched alkyl group having 1 to 10 carbon atoms is 15 wt % to 25 wt %, and the content of the hydroxyl group-containing monomer is 10 wt % to 25 wt %, based on the total amount (100 wt %) of the monomer components constituting the acrylic polymer.

(b) An aspect that at least includes, as monomer components, alkyl ester acrylate having a linear or branched alkyl group having 6 to 10 carbon atoms; and at least one monomer selected from the group consisting of a nitrogen-containing monomer and ester (meth)acrylate having an alicyclic hydrocarbon group; and a hydroxyl group-containing monomer, wherein the content of the alkyl ester acrylate having a linear or branched alkyl group having 6 to 10 carbon atoms is 45 wt % to 55 wt %, the total content of the at least one monomer selected from the group consisting of the nitrogen-containing monomer and the ester (meth)acrylate having a alicyclic hydrocarbon group is 20 wt % to 45 wt %, and the content of the hydroxyl group-containing monomer is 5 parts to 10 wt %, based on the total amount (100 wt %) of the monomer components constituting the acrylic polymer.

The aspect (a) includes the following aspects (a1) and (a2).

(a1) An aspect that at least includes, as monomer components, alkyl ester acrylate having a linear or branched alkyl group having 6 to 10 carbon atoms, ester (meth)acrylate having an alicyclic hydrocarbon group, alkyl ester methacrylate having a linear or branched alkyl group having 1 to 10 carbon atoms, and a hydroxyl group-containing monomer, wherein the content of the alkyl ester acrylate having a linear or branched alkyl group having 6 to 10 carbon atoms is 45 wt % to 55 wt %, the content of the ester (meth)acrylate having an alicyclic hydrocarbon group is 10 wt % to 25 wt %, the content of the alkyl ester methacrylate having a linear or branched alkyl group having 1 to 10 carbon atoms is 15 wt % to 25 wt %, and the content of the hydroxyl group-containing monomer is 10 wt % to 25 wt %, based on the total amount (100 wt %) of the monomer components constituting the acrylic polymer.

In aspect (a1), a nitrogen-containing monomer is not included as a monomer component.

(a2) An aspect that at least includes, as monomer components, alkyl ester acrylate having a linear or branched alkyl group having 6 to 10 carbon atoms, a nitrogen-containing monomer, alkyl ester methacrylate having a linear or branched alkyl group having 1 to 10 carbon atoms, and a hydroxyl group-containing monomer, wherein the content of the alkyl ester acrylate having a linear or branched alkyl group having 6 to 10 carbon atoms is 45 wt % to 55 wt %, the content of the nitrogen-containing monomer is 10 wt % to 25 wt %, the content of the alkyl ester methacrylate having a linear or branched alkyl group having 1 to 10 carbon atoms is 15 wt % to 25 wt %, and the content of the hydroxyl group-containing monomer is 10 wt % to 25 wt %, based on the total amount (100 wt %) of the monomer components constituting the acrylic polymer.

In aspect (a2), ester (meth)acrylate having an alicyclic hydrocarbon group is not included as a monomer component.

The aspect (b) is appropriate when an acrylic polymer is obtained by using the following active energy-ray polymerization method.

(Meth)acrylic acid is not used as a monomer component constituting an acrylic polymer in either of the above aspects, and thus unreacted (meth)acrylic acid is not substantially present in a pressure-sensitive adhesive layer to be formed. Accordingly, in the above aspects, corrosion resistance of a metal thin film or metal electrode and a CNT (carbon nanotube) film is excellent.

The acrylic polymer is obtained by polymerizing the monomer components using a known/general polymerization method. As the polymerization method of the acrylic polymer, examples thereof include a solution polymerization method, an emulsion polymerization method, a bulk polymerization method and, a polymerization method by an active energy-ray irradiation (active energy-ray polymerization method). Among the methods, the solution polymerization method and the active energy-ray polymerization method are preferable from the viewpoint of productivity.

The active energy-ray irradiated in the active energy-ray polymerization (photopolymerization) may be, for example, an alpha ray, a beta ray, a gamma ray, a neutron ray, and an ionizing radiation such as an electron ray or UV. In particular, UV is preferable. An irradiation energy, an irradiation time and an irradiation method of the active energy-ray are not particularly limited so long as the monomer components may be reacted by activating a photopolymerization initiator.

In the solution polymerization, the solvent used therein is not particularly limited, but various kinds of general solvents can be used. Examples of such a solvent include organic solvents such as: esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methylethylketone and methylisobutylketone. The solvents may be used either alone or in combination of two or more thereof.

When the acrylic polymer is obtained, a polymerization initiator such as a photopolymerization initiator (photoinitiator) and a thermal polymerization initiator is preferably used depending on the kind of polymerization reaction in the polymerization of monomer components. The polymerization initiator may be used either alone or in combination of two or more thereof.

The photopolymerization initiator may include, but not particularly limited to, for example, a benzoin ether photopolymerization initiator, an acetophenon photopolymerization initiator, an α-ketol photopolymerization initiator, an aromatic sulfonyl chloride photopolymerization initiator, a photoactive oxime photopolymerization initiator, a benzoin photopolymerization initiator, a benzyl photopolymerization initiator, a benzophenon photopolymerization initiator, a ketal photopolymerization initiator and a thioxantone photopolymerization initiator. The content of the photopolymerization initiator used is not particularly limited, but for example, is preferably 0.01 to 0.2 parts by weight, and more preferably 0.05 to 0.15 parts by weight based on 100 parts by weight of the total amount of the monomer components constituting the acrylic polymer.

As the benzoin ether photopolymerization initiator, examples thereof include benzoin methyl ether, benzoin ethyl ether, benzoin propyl ether, benzoin isopropyl ether, benzoin isobutyl ether, 2,2-dimethoxy-1,2-diphenylethane-1-on and anisole methyl ether. As the acetophenon photopolymerization initiator, examples thereof include 2,2-diethoxyacetophenon, 2,2-dimethoxy-2-phenylacetophenon, 1-hydroxycyclohexylphenylketone, 4-phenoxydichloroacetophenon and 4-(t-butyl)dichloroacetophenon. As the α-ketol photopolymerization initiator, examples thereof include 2-methyl-2-hydroxypropiophenon and 1-[4-(2-hydroxyethyl)phenyl]-2-methylpropane-1-on. As the aromatic sulfonyl chloride photopolymerization initiator, examples thereof include 2-naphthalenesulfonyl chloride. As the photoactive oxime photopolymerization initiator, examples thereof include 1-phenyl-1,1-propanedion-2-(o-ethoxycarbonyl)-oxime. As the benzoine photopolymerization initiator, examples thereof include benzoin. As the benzyl photopolymerization initiator, examples thereof include benzyl. As the benzophenon photopolymerization initiator, examples thereof include benzophenon, benzoylbenzoate, 3,3′-dimethyl-4-methoxybenzophenon, polyvinylbenzophenon and α-hydroxycyclohexyl phenyl ketone. As the ketal photopolymerization initiator, examples thereof include benzyl dimethyl ketal. As the thioxantone photopolymerization initiator, examples thereof include thioxantone, 2-chlorothioxantone, 2-methylthioxantone, 2,4-dimethylthioxantone, isopropylthioxantone, 2,4-diisopropylthioxantone and dodecylthioxantone.

The polymerization initiator (thermal polymerization initiator) used when the acrylic polymer is prepared by the solution polymerization, may be, for example, an azo initiator, a peroxide polymerization initiator (for example, dibenzoyl peroxide and tert-butyl permaleate) and a redox polymerization initiator. Among the initiators, the azo initiator disclosed in JP 2002-69411 A is particularly preferable.

As the azo initiator, examples thereof include 2,2′-azobisisobutyronitrile (hereinafter, referred to as AIBN in some cases), 2,2′-azobis-2-methylbutyronitrile (hereinafter, referred to as AMBN in some cases), dimethyl 2,2′-azobis(2-methylpropionate) and 4,4′-azobis-4-cyanovaleric acid.

The content of the thermal polymerization initiator is not particularly limited. For example, the content of the azo initiator used is preferably 0.05 to 0.5 parts by weight, and more preferably 0.1 to 0.3 parts by weight based on 100 parts by weight of the total amount of the monomer components constituting the acrylic polymer.

In the composition (pressure-sensitive adhesive composition), especially acrylic pressure-sensitive adhesive composition, for forming the pressure-sensitive adhesive layer of the present invention, if necessary, additives such as a crosslinking agent, a crosslinking accelerator, a silane coupling agent, a tackifying resin (rosin derivative, polyterphen resin, petroleum resin, and oil-soluble phenol), an antiaging agent, a filler, a colorant (dye or pigment), a UV absorbing agent, an antioxidant, a chain-transfer agent, a plasticizer, a softener, a surfactant and an antistatic agent may be used as long as the property of the present invention is impaired. When the pressure-sensitive adhesive layer of the present invention is formed, various general solvents may be used. The solvent is not particularly limited, and examples thereof include any solvents used in the solution polymerization method as described above. The additive may be used either alone or in combination of two or more thereof.

If a crosslinking agent is included in the pressure-sensitive adhesive composition, a crosslinked structure may be obtained by a base polymer in the pressure-sensitive adhesive layer to be formed, and thus a gel fraction of the pressure-sensitive adhesive layer can be controlled. For example, if a crosslinking agent is included in the acrylic pressure-sensitive adhesive composition, the gel fraction is controlled by crosslinking of the acrylic polymers in the acrylic pressure-sensitive adhesive layer to be formed. For example, when the gel fraction (solvent insoluble matter) of the pressure-sensitive adhesive layer is controlled to be in a range of 40 wt % to 95 wt %, the durability of the pressure-sensitive adhesive layer is improved.

The crosslinking agent is not particularly limited, but examples thereof include an isocyanate-based crosslinking agent, an epoxy-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, a carbodiimide-based crosslinking agent, an oxazoline-based crosslinking agent, an aziridine-based crosslinking agent and an amine-based crosslinking agent. The crosslinking agent may be used either alone or in combination of two or more thereof. Among the crosslinking agents, the cross-linking agent is preferably the isocyanate-based crosslinking agent or the epoxy-based crosslinking agent, and more preferably the isocyanate-based crosslinking agent, from the viewpoint of improvement of the durability.

As the isocyanate-based crosslinking agent (polyfunctional isocyanate compound), examples thereof include lower aliphatic polyisocyanates such as 1,2-ethylene diisocyanate, 1,4-butylenediisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. The isocyanate-based crosslinking agent may be, for example, commercially available products such as a trimethylolpropane/tolylene diisocyanate adduct (manufactured by Nippon Polyurethane Industry Co., Ltd., trade name “CORONATE L”), a trimethylolpropane/hexamethylene diisocyanate adduct (manufactured by Nippon Polyurethane Industry Co., Ltd., trade name “CORONATE HL”), a trimethylolpropane/xylylene diisocyanate adduct (manufactured by Mitsui Chemicals Co., Ltd., trade name “TAKENATE D110N”).

As the epoxy-based crosslinking agent (polyfunctional epoxy compound), examples thereof include N,N,N′,N′-tetraglycidyl-m-xylenediamine, diglycidyl aniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic diglycidyl ester, triglycidyl-tris(2-hydroxyethyl)isocyanurate, resorcin diglycidyl ether, bisphenol-S-diglycidyl ether and an epoxy-based resin having two or more epoxy groups in the molecule. The epoxy-based crosslinking agent may be, for example, commercially available products such as trade name “TETRAD C” manufactured by Mitsubishi Gas Chemical Company, Inc.

The content of the crosslinking agent in the pressure-sensitive adhesive composition is not particularly limited, but for example, is preferably 0.001 to 10 parts by weight, and more preferably 0.01 to 5 parts by weight based on the total amount (100 parts by weight) of the monomer components constituting the acrylic polymer. By setting the content to 0.001 parts by weight or more, the durability is improved. On the other hand, by setting the content to 10 parts by weight or less, the step absorbability is improved.

A crosslinking accelerator (crosslinking aid) may be included in the pressure-sensitive adhesive composition for the purpose of accelerating the crosslinking reaction. The crosslinking accelerator is not particularly limited, but an amine-based compound containing a plurality of hydroxyl groups may be preferably used. The amine-based compound containing a plurality of hydroxyl groups is not particularly limited so long as the compound is an amine-based compound having at least two hydroxyl groups (alcoholic hydroxyl group) in the molecule, but for example, the amine-based compound containing a plurality of hydroxyl groups disclosed in JP 2009-079203 A may be preferably used. If the amine-based compound containing a plurality of hydroxyl groups is used, crosslinking speed is accelerated, so that productivity is improved. The amine-based compound may be commercially available products such as trade names of “EDP-300”, “EDP-450”, “EDP-1100” and “Pluronic” (manufactured by ADEKA Corp.).

The content of the crosslinking accelerator in the pressure-sensitive adhesive composition is not particularly limited, but for example, the content of the amine-based compound containing a plurality of hydroxyl groups in the acrylic pressure-sensitive adhesive composition is preferably 0.01 parts to 5.0 parts by weight, and more preferably 0.05 parts to 1.0 part by weight based on the total amount (100 parts by weight) of the monomer components constituting the acrylic polymer, from the viewpoint of accelerating the crosslinking speed to decrease the aging time, thereby improving the productivity.

The pressure-sensitive adhesive composition (especially, the acrylic pressure-sensitive adhesive composition) may include a silane coupling agent for the purpose of improving an adhesion property to glass (in particular, adhesion reliability to glass at high temperature and high humidity environment). The silane coupling agent is not particularly limited, but γ-glycidoxypropyltrimethoxysilane, γ-glycidoxypropyltriethoxysilane, γ-aminopropyltrimethoxysilane and N-phenyl-aminopropyltrimethoxysilane are preferably exemplified. Among them, γ-glycidoxypropyltrimethoxysilane is preferable. As the silane coupling agent, for example, a commercially available product such as trade name “KBM-403” (manufactured by Shin-Etsu Chemical Co., Ltd.) may be used. The silane coupling agent may be used alone or in combination of two or more thereof.

The content of the silane coupling agent in the pressure-sensitive adhesive composition is not particularly limited. However, for example in the acrylic pressure-sensitive adhesive composition, the content thereof is preferably 0.01 to 1 part by weight, and more preferably 0.03 to 0.5 parts by weight based on the total amount (100 parts by weight) of the monomer components constituting the acrylic polymer, from the standpoint of improvement of adhesion reliability to glass.

A method for forming the pressure-sensitive adhesive layer of the present invention is not particularly limited, but a known and general method for forming the pressure-sensitive adhesive layer may be used. For example, the following methods (1) to (3) may be used.

(1) A method for forming a pressure-sensitive adhesive layer, including applying (coating) a pressure-sensitive adhesive composition including a monomer mixture or partially polymerized products thereof and, if necessary, an additive such as a photopolymerization initiator on a substrate or a separator, and irradiating active energy-ray (in particular, UV) thereto.

(2) A method for forming a pressure-sensitive adhesive layer, including applying (coating) a pressure-sensitive adhesive composition (solution) including a polymer (base polymer), a solvent and, if necessary, an additive on a substrate or a separator, and drying and/or curing the composition.

(3) The pressure-sensitive adhesive layer formed in the above (1) is further dried.

In the above method, a heating/drying process may be employed, if necessary.

In the method for forming the pressure-sensitive layer of the present invention, coating may be performed by a known coating method. For example, a general coater such as a gravure roll coater, a reverse roll coater, a kiss roll coater, a dip roll coater, a bar coater, a knife coater, a spray coater, a comma coater and a direct coater may be used.

The thickness of the pressure-sensitive adhesive layer of the present invention is not particularly limited, but is preferably 10 μm to 500 μm, and more preferably 10 μm to 350 μm. The pressure-sensitive adhesive layer may be a single-layer structure or a laminated structure.

[Other Pressure-Sensitive Adhesive Layers]

The optical pressure-sensitive adhesive sheet of the present invention may include pressure-sensitive adhesive layers other than the pressure-sensitive adhesive layer of the present invention (other pressure-sensitive adhesive layers), and the other pressure-sensitive adhesive layers is not particularly limited, but for example, examples thereof include a known/general pressure-sensitive adhesive layer that is formed of a known pressure-sensitive adhesive such as an urethane-based pressure-sensitive adhesive, an acrylic pressure-sensitive adhesive, a rubber-based pressure-sensitive adhesive, a silicon-based pressure-sensitive adhesive, a polyester-based pressure-sensitive adhesive, a polyamide-based pressure-sensitive adhesive, an epoxy-based pressure-sensitive adhesive, a vinyl alkyl ether-based pressure-sensitive adhesive and a fluorine-based pressure-sensitive adhesive. The other pressure-sensitive adhesive layer may be formed by a pressure-sensitive adhesive which is in combination of two or more of the known pressure-sensitive adhesives.

[Substrate]

The optical pressure-sensitive adhesive sheet of the present invention may be a pressure-sensitive adhesive sheet with substrate. The substrate is not particularly limited, but may be various films (for example, the optical film to be described below) such as a plastic film, an antireflection (AR) film, a polarizing plate, and a retardation film. Materials of the plastic film may be, for example, plastic material such as polyester resins such as polyethylene terephthalate (PET); acrylic resins such as polymethyl methacrylate (PMMA); polycarbonate; triacetyl celluous (TAC); polysulfone; polyarylate; polyimide; polyvinyl chloride; polyvinyl acetate; polyethylene; polypropylene; ethylene propylene copolymer; and cyclic olefin polymer such as trade name “ARTON (cyclic olefin polymer; manufactured by JSR)”, trade name “ZEONOR (cyclic olefin polymer; manufactured by Nippon Zeon Co., Ltd.)”. The plastic materials may be used alone or in combination of two or more thereof. The “substrate” is a part laminated to an adherend together with the pressure-sensitive adhesive layer, when the pressure-sensitive adhesive sheet is used (laminated) to the adherend (such as an optical member). The separator (release liner) released in the use (lamination) of the pressure-sensitive adhesive sheet is not included in the “substrate”.

Among them, the substrate is preferably a transparent substrate. The total light transmittance of the substrate in a visible light wavelength region (in accordance with JIS K7361) is not particularly limited, but is preferably 85% or more, and more preferably 88% or more. A haze of the substrate (in accordance with JIS K7136) is not particularly limited, but is preferably 1.5% or less, and more preferably 1.0% or less. The transparent substrate may be a PET film or a non-oriented film such as trade name “ARTON”, and trade name “Zeonoa”.

The thickness of the substrate is not particularly limited, but for example, is preferably 12 to 75 μm. The substrate may have a single layer or multilayer shape. On the surface of the substrate, for example, a known/general surface treatment such as a physical treatment such as a corona discharge treatment and a plasma treatment and a chemical treatment such as a basecoat treatment, may be properly preformed.

[Optical Pressure-Sensitive Adhesive Sheet]

The optical pressure-sensitive adhesive sheet of the present invention has at least one pressure-sensitive adhesive layer of the present invention. It is preferred that the optical pressure-sensitive adhesive sheet of the present invention is a substrateless type pressure-sensitive adhesive sheet consisting of the pressure-sensitive adhesive layer of the present invention.

The total amount of the acrylic acid ion and methacrylic acid ion extracted from the optical pressure-sensitive adhesive sheet of the present invention under the condition of 100° C. and 45 min with pure water (the amount of the extracted (meth)acrylic acid ion), which is measured by an ion chromatograph method, is not particularly limited, but is preferably 300 ng/cm² or less (for example, 0 ng/cm² to 300 ng/cm²), more preferably 0 ng/cm² to 150 ng/cm², and even more preferably 0 ng/cm² to 100 ng/cm² per unit area of the pressure-sensitive adhesive layer of the present invention, when the optical pressure-sensitive adhesive sheet of the present invention has a thickness of 150 μm or more. When the optical pressure-sensitive adhesive sheet of the present invention has a thickness of 100 μm or more and less than 150 μm, the amount is preferably 100 ng/cm² or less (for example, 0 ng/cm² to 100 ng/cm²), and more preferably 0 ng/cm² to 80 ng/cm² per unit area of the pressure-sensitive adhesive layer of the present invention. When the optical pressure-sensitive adhesive sheet of the present invention has a thickness of 75 μm or more and less than 100 μm, the amount is preferably 80 ng/cm² or less (for example, 0 ng/cm² to 80 ng/cm²), and more preferably 0 ng/cm² to 50 ng/cm² per unit area of the pressure-sensitive adhesive layer of the present invention. When the optical pressure-sensitive adhesive sheet of the present invention has a thickness of less than 75 μm, the amount is preferably 20 ng/cm² or less (for example, 0 ng/cm² to 20 ng/cm²), more preferably 0 ng/cm² to 17 ng/cm², and even more preferably 0 ng/cm² to 15 ng/cm² per unit area of the pressure-sensitive adhesive layer of the present invention.

The amount of the extracted (meth)acrylic acid ion shows the degree of easiness of dissociation of the acrylic acid ion and methacrylic acid ion by moisture from the pressure-sensitive adhesive layer when the pressure-sensitive adhesive sheet is put under the humidified environment. By setting the amount of the extracted (meth)acrylic acid ion to 20 ng/cm² or less, even though the sheet is stored in the presence of moisture such as the humidified environment in a state where the sheet is laminated to a metal thin film, the metal thin film is hardly corroded and thus the corrosion resistance is improved. In the optical pressure-sensitive adhesive sheet of the present invention, a property that the adherend is hardly corroded is called “corrosion resistance” or “anti-corrosion property” in some cases.

The “total amount of the acrylic acid ion and methacrylic acid ion extracted from the pressure-sensitive adhesive sheet of the present invention under the condition of 100° C. and 45 min with pure water, which is measured by the ion chromatograph method”, can be measured by using the following method.

First, the pressure-sensitive adhesive sheet is cut into an appropriate size, and in the case where the separator is provided, the separator is peeled, and the pressure-sensitive adhesive surface is exposed, which is used as the sample. In the case of the double-sided pressure-sensitive adhesive sheet, only one pressure-sensitive adhesive surface is exposed by laminating the PET film (thickness of 25 to 50 μm) to the other pressure-sensitive adhesive surface. In this case, the pressure-sensitive adhesive surface laminated to the metal thin film (in the case of the pressure-sensitive adhesive sheet of the present invention, the surface of the pressure-sensitive adhesive layer side of the present invention) is exposed. The size of the sample (exposure area of the pressure-sensitive adhesive surface) is preferably 100 cm².

Subsequently, the sample is put into pure water having a temperature of 100° C., followed by boiling for 45 min, and boiling extraction of the acrylic acid ion and methacrylic acid ion is performed.

Subsequently, the total amount (unit: ng) of the acrylic acid ion and methacrylic acid ion in the obtained extraction solution is measured by using the ion chromatograph method (ion chromatography), and the total amount (unit: ng/cm²) of the acrylic acid ion and methacrylic acid ion per unit area of the pressure-sensitive adhesive surface (exposed pressure-sensitive adhesive surface) of the sample is calculated. The measuring condition of the ion chromatograph method (ion chromatography) is not particularly limited, but for example, the following condition is exemplified.

(Measurement Conditions of Ion Chromatography)

Analysis device: DX-320, manufactured by DIONEX Co., Ltd.

Separation column: Ion Pac AS15 (4 mm×250 mm)

Guard column: Ion Pac AG15 (4 mm×50 mm)

Removal system: ASRS-ULTRA (External mode, 100 mA)

Detector: electric conductivity detector

Eluent: 7 mM KOH (0 to 20 min)
45 mM KOH (20 to 30 min)
(eluent generator EG40 is used)

Flow rate of eluent: 1.0 ml/min

Injection amount of sample: 250 μl

The (meth)acrylic acid ion dissociated by moisture from the pressure-sensitive adhesive sheet generally comes from the (meth)acrylic acid existing in the pressure-sensitive adhesive layer. It is assumed that the reason is that the (meth)acrylic acid ion disturbs conduction by penetrating the metal thin film due to moisture under the high temperature and high humidity environment, thereby causing an increase in resistance of the metal thin film (corrosion of the metal thin film). In general, in the case where a large amount (for example, 10 wt % or more) of (meth)acrylic acid (in particular, acrylic acid) is used as the monomer component constituting the acrylic polymer for the purpose of improving the adhesion property of the pressure-sensitive adhesive sheet, unreacted (meth)acrylic acid easily remains in the pressure-sensitive adhesive layer, so that the (meth)acrylic acid ion dissociated by moisture from the pressure-sensitive adhesive sheet is also increased. On the other hand, in the present invention, in the case where the (meth)acrylic acid remaining in the pressure-sensitive adhesive layer is decreased by sufficiently performing drying at the time of forming the pressure-sensitive adhesive layer, increasing the polymerization time of the acrylic polymer, or decreasing the amount of (meth)acrylic acid used as the monomer component, the (meth)acrylic acid ion dissociated by moisture from the pressure-sensitive adhesive sheet is small, so that corrosion of the metal thin film as the adherend or increase in resistance, which are caused thereby, is suppressed.

The total light transmittance of the optical pressure-sensitive adhesive sheet of the present invention in a visible light wavelength region (in accordance with JIS K7361) is not particularly limited, but is preferably 90% or more and more preferably 91% or more, in that transparency or an appearance of an optical product or optical member in which the pressure-sensitive adhesive sheet is used is prevented from being negatively affected. The total light transmittance of the pressure-sensitive adhesive sheet can be measured, for example, by using a haze meter (manufactured by Murakami Color Research Laboratory Co., Ltd., trade name “HM-150”) by laminating the pressure-sensitive adhesive sheet to a slide glass (for example, total light transmittance of 91.8% and haze of 0.4%).

The haze of the optical pressure-sensitive adhesive sheet of the present invention (in accordance with JIS K7136) is not particularly limited, but is preferably 3% or less, and more preferably 1% or less, in that transparency or an appearance of an optical product or optical member in which the pressure-sensitive adhesive sheet is used is prevented from being negatively affected. The haze of the pressure-sensitive adhesive sheet can be measured, for example, by using a haze meter (manufactured by Murakami Color Research Laboratory Co, Ltd., trade name “HM-150”) by laminating the pressure-sensitive adhesive sheet to a slide glass (for example, total light transmittance of 91.8% and haze of 0.4%).

The thickness of the optical pressure-sensitive adhesive sheet of the present invention is not particularly limited, but is preferably 10 μm to 500 μm, and more preferably 10 μm to 350 μm.

The pressure-sensitive adhesive surface of the optical pressure-sensitive adhesive sheet of the present invention may be protected by the separator (release liner) until it is used. In the case where the optical pressure-sensitive adhesive sheet of the present invention is a double-sided pressure-sensitive adhesive sheet, each pressure-sensitive adhesive surface may be protected by using separators, respectively, or protected in such a way that the surface is wound in a roll form by using one separator of which both sides are release surfaces. The separator is used as a protective material of the pressure-sensitive adhesive layer, and peeled when the pressure-sensitive adhesive layer is laminated to the adherend. In the case where the optical pressure-sensitive adhesive sheet of the present invention is a substrateless pressure-sensitive adhesive sheet, the separator functions as a support of the pressure-sensitive adhesive layer. The separator may not be provided in the optical pressure-sensitive adhesive sheet of the present invention.

The separator is not particularly limited, but any known release paper and the like are exemplified. In addition, examples thereof also includes a separator having a release treated layer, a low adhesive substrate composed of a fluorine polymer, or a low adhesive substrate composed of a non-polar polymer. As the separator having the release treated layer, examples thereof include a plastic film or paper whose surface is treated by a release agent such as silicon type, long-chain alkyl type, fluorine type, and molybdenum sulfide. As the fluorine-based polymer in the low adhesive substrate composed of fluorine polymer, examples thereof include polytetrafluoroethylene, polychlorotrifluoroethylene, polyvinyl fluoride, polyvinylidene fluoride, a tetrafluoroethylene-hexafluoropropylene copolymer and a chlorofluoroethylene-vinylidene fluoride copolymer. As the non-polar polymer, examples thereof include an olefine-based resin (for example, polyethylene, polypropylene and the like). The separator can be formed by using a known/general method. The thickness of the separator is not particularly limited.

A method for manufacturing the optical pressure-sensitive adhesive sheet of the present invention is not particularly limited, but a known/general method may be used. For example, a substrateless type pressure-sensitive adhesive sheet consisting of the pressure-sensitive adhesive layer of the present invention is manufactured by forming the pressure-sensitive adhesive layer of the present invention on the separator. A pressure-sensitive adhesive sheet with substrate which has the pressure-sensitive adhesive layer of the present invention on at least one surface of a substrate is manufactured by forming the pressure-sensitive adhesive layer of the present invention on the substrate or transferring the pressure-sensitive adhesive layer of the present invention separately manufactured onto the substrate.

Since the optical pressure-sensitive adhesive sheet of the present invention has the pressure-sensitive adhesive layer of the present invention, the sheet has low relative dielectric constant. For this reason, the whole thickness can be decreased while a desired electric capacitance is maintained, from the following equation (1). Thus, the optical pressure-sensitive adhesive sheet of the present invention is appropriately used in optical products in which thinning is required, such as an electrostatic capacity type touch panel.

C=∈₀·∈_{S}·S/L (1)

C: Electric capacitance

∈₀: Vacuum permittivity

∈_{S}: Relative dielectric constant

S: Area

L: Thickness

Since the optical pressure-sensitive adhesive sheet of the present invention has the pressure-sensitive adhesive layer of the present invention, white turbidity is not caused by humidification. For this reason, the optical pressure-sensitive adhesive sheet of the present invention can prevent deterioration of visibility or appearance of a display unit in products using the pressure-sensitive adhesive sheet.

The optical pressure-sensitive adhesive sheet of the present invention has excellent corrosion resistance. Since adhesion property to an adherend or a property that does not generate foam or release (antifoaming release property) is excellent, adhesive reliability is excellent.

The optical pressure-sensitive adhesive sheet of the present invention is used in laminating optical members or in manufacturing optical products. If the optical pressure-sensitive adhesive sheet of the present invention is used for these purposes, phenomena such as an occurrence of bubbles or lift-off and white turbidity that may obscure visibility or an appearance of a product are suppressed, so that it is possible to obtain a product having an excellent appearance.

The optical pressure-sensitive adhesive sheet of the present invention is preferably used in laminating the optical members used in the optical product. The optical member refers to a member having an optical characteristic (for example, a polarized property, a photorefractive property, a light scattering property, a light reflective property, a light transmitting property, a light absorbing property, a light diffractive property, an optical rotation property and visibility). The optical member is not particularly limited so long as the optical member is the member having the optical characteristic, and examples thereof include a polarizing plate, a wave plate, a retardation plate, an optical compensation film, a brightness enhancing film, a light guide plate, a reflective film, an anti-reflective film, a transparent conductive film (e.g. ITO film), a design film, a decoration film, a surface protective film, a prism, lens, a color filter, a transparent substrate, and a member in which these are laminated (collectively referred to as “an optical film” in some cases). Each of the “plate” and the “film” include a plate shape, a film shape, and a sheet shape, and for example, the “polarizing film” includes a “polarizing plate” and a “polarizing sheet”. For example, by laminating the optical film by using the optical pressure-sensitive adhesive sheet of the present invention, or by laminating the substrateless type optical pressure-sensitive adhesive sheet of the present invention to at least one surface of the optical film, it is possible to obtain the optical film having the optical pressure-sensitive adhesive sheet of the present invention.

In particular, in the case where the optical pressure-sensitive adhesive sheet of the present invention is a double-sided pressure-sensitive adhesive sheet, by attaching the optical pressure-sensitive adhesive sheet of the present invention to at least one surface of various optical films and laminating them, it is possible to obtain a pressure-sensitive adhesive type optical film including the pressure-sensitive adhesive layer of the present invention on at least one surface of the optical film (optical film including the optical pressure-sensitive adhesive sheet of the present invention). The optical pressure-sensitive adhesive sheet of the present invention (double-sided pressure-sensitive adhesive sheet) used in the pressure-sensitive adhesive type optical film may be a substrateless pressure-sensitive adhesive sheet or a pressure-sensitive adhesive sheet with substrate.

A material constituting the optical member is not particularly limited, but examples thereof include, for example, a plastic material such as an acrylic resin (in particular, polymethyl methacrylate resin (PMMA)), a polycarbonate resin and polyethylene terephthalate, glass and metal (including metal oxide).

The optical pressure-sensitive adhesive sheet of the present invention is preferably used when manufacturing a display device (image display device) such as a liquid crystal display device, an organic EL (electroluminescence) display device, a PDP (plasma display panel) and an electronic paper. The optical pressure-sensitive adhesive sheet of the present invention is also preferably used when manufacturing an input device such as a touch panel. For example, it is possible to obtain a display device including the optical pressure-sensitive adhesive sheet of the present invention by manufacturing the display device by using the optical member (for example, optical film) including the optical pressure-sensitive adhesive sheet of the present invention, or by manufacturing the display device by using the optical pressure-sensitive adhesive sheet of the present invention.

When the amount of the extracted (meth)acrylic acid ion is controlled within a predetermined range, the optical pressure-sensitive adhesive sheet of the present invention can exhibit excellent corrosion resistance and, in particular, is preferably used for the purpose of being laminated to a metal thin film or a metal electrode and a CNT (carbon nanotube) film. The metal thin film may be a thin film formed of metal, metal oxide or a mixture thereof, and is not particularly limited. However, examples thereof include a thin film of ITO (indium tin oxide), ZnO, SnO and CTO (cadmium tin oxide). The thickness of the metal thin film is not particularly limited, but is preferably 100 Å to 2,000 Å. The metal thin film such as ITO is formed on, for example, the PET film, and is used as a transparent conductive film. When the pressure-sensitive adhesive sheet of the present invention is laminated to the metal thin film, it is preferred that the surface of the pressure-sensitive adhesive layer side of the present invention is used to be a pressure-sensitive adhesive surface on a side to which the metal thin film is laminated.

The metal electrode is not particularly limited so long as the electrode is metal, metal oxide or a mixture thereof, but examples thereof include an electrode formed of ITO, silver or copper.

As an example of a specific use application of the optical pressure-sensitive adhesive sheet of the present invention, there may be a pressure-sensitive adhesive sheet for a touch panel used in manufacturing the touch panel. For example, when manufacturing an electrostatic capacity type touch panel, a transparent conductive film on which a metal thin film such as ITO is formed, a polymethyl methacrylate resin (PMMA) plate, a hard coat film, a glass lens and the like may be used for being laminated through the optical pressure-sensitive adhesive sheet of the present invention. The touch panel is not particularly limited, but for example, is used in a cellular phone, a tablet computer and a mobile information terminal.

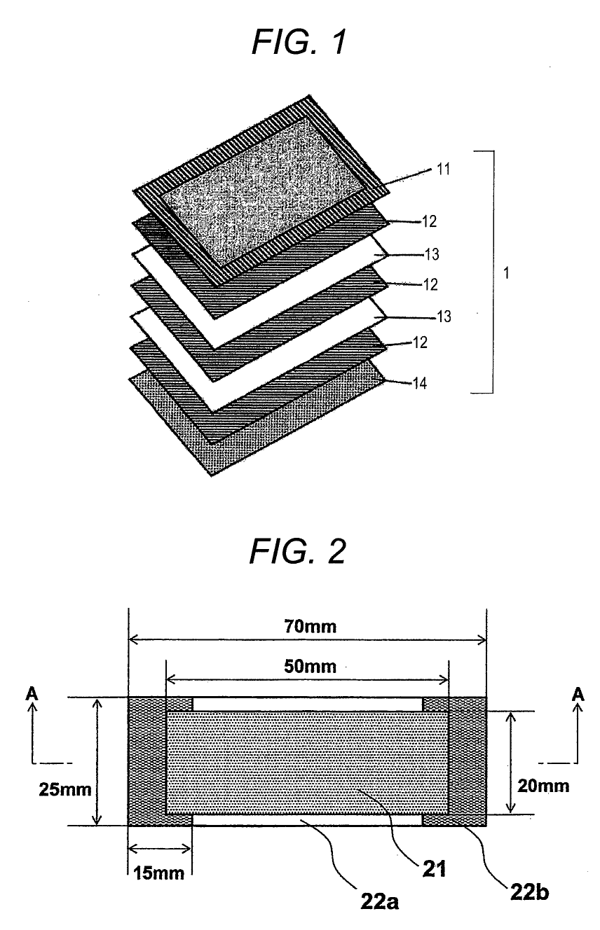

As a more specific example, an example of an electrostatic capacity type touch panel in which the optical pressure-sensitive adhesive sheet of the present invention is used is shown in FIG. 1. In FIG. 1, reference numeral 1 represents an electrostatic capacity type touch panel, reference numeral 11 represents a decorative panel, reference numeral 12 represents an optical pressure-sensitive adhesive sheet, reference numeral 13 represents an ITO film, and reference numeral 14 represents a hard coat film. The decorative panel 11 is preferably a glass plate or a transparent acrylic plate (PMMA plate). In the ITO film 13, it is preferred that an ITO film is formed on a glass plate or a transparent plastic film (in particular, PET film). In the hard coat film 14, it is preferred that a hard coat treatment is performed on a transparent plastic film such as a PET film.

Since the optical pressure-sensitive adhesive sheet of the present invention is used in the electrostatic capacity type touch panel 1, the thickness thereof can be thinner and thus operation stability is excellent. An appearance or visibility is good, and white turbidity does not occur even under a high temperature environment or a high temperature and high humidity environment.

Hereinafter, the present invention will be described in more detail based on the Examples, but the present invention is not limited to the Examples. The mixing amount of “TAKENATE D110N” (solid content: 75 wt %) in the following description and Table 2 was represented by the mixing amount (parts by weight) in terms of the solid content of “TAKENATE D110N”.

### Example 1

46 parts by weight of 2-ethylhexyl acrylate (2EHA), 15 parts by weight of N-vinyl-2-pyrrolidone (NVP), 18 parts by weight of methyl methacrylate (MMA) and 21 parts by weight of 2-hydroxyethyl acrylate (HEA) as monomer components, 0.2 parts by weight of 2,2′-azobisisobutyronitrile (AIBN) as a polymerization initiator, and 122 parts by weight of ethyl acetate and 40.7 parts by weight of toluene as a polymerization solvent were put into a separable flask, followed by stirring for 1 hour while nitrogen gas was introduced. After oxygen in the polymerization system was removed thereby, the system was heated to 65° C., followed by reacting for 10 hours, and thereafter, ethyl acetate was added thereto to obtain an acrylic polymer solution having a solid concentration of 36 wt %.

A pressure-sensitive adhesive composition (solution) was prepared by adding 0.3 parts by weight of an isocyanate-based crosslinking agent (manufactured by Mitsui Chemicals, Inc., trade name “TAKENATE D110N”) as a crosslinking agent thereto based on 100 parts by weight of the acrylic polymer in the acrylic polymer solution, and mixing them.

Subsequently, the pressure-sensitive adhesive composition (solution) was applied on a release-treated surface of a PET separator having a thickness of 50 μm (manufactured by Teijin DuPont Films Japan Limited, trade name “Purex A43”) such that the thickness after drying was 50 μm, followed by heating and drying at 130° C. for 3 min to form a pressure-sensitive adhesive layer, thereby obtaining a pressure-sensitive adhesive sheet (substrateless double-sided pressure-sensitive adhesive sheet).

### Example 2

46 parts by weight of 2-ethylhexyl acrylate (2EHA), 15 parts by weight of N-vinyl-2-pyrrolidone (NVP), 24 parts by weight of methyl methacrylate (MMA) and 21 parts by weight of 2-hydroxyethyl acrylate (HEA) as monomer components, 0.2 parts by weight of 2,2′-azobisisobutyronitrile (AIBN) as a polymerization initiator, and 163 parts by weight of ethyl acetate as a polymerization solvent were put into a separable flask, followed by stirring for 1 hour while nitrogen gas was introduced. After oxygen in the polymerization system was removed thereby, the system was heated to 65° C., followed by reacting for 7 hours, and thereafter, ethyl acetate was added thereto to obtain an acrylic polymer solution having a solid concentration of 36 wt %.

A pressure-sensitive adhesive composition (solution) was prepared by adding 0.3 parts by weight of an isocyanate-based crosslinking agent (manufactured by Mitsui Chemicals, Inc., trade name “TAKENATE D110N”) as a crosslinking agent thereto based on 100 parts by weight of the acrylic polymer in the acrylic polymer solution, and mixing them.

Subsequently, a pressure-sensitive adhesive sheet (substrateless double-sided pressure-sensitive adhesive sheet) was obtained in the same manner as in Example 1 from the pressure-sensitive adhesive composition (solution).

### Example 3

55 parts by weight of 2-ethylhexyl acrylate (2EHA), 20 parts by weight of N-vinyl-2-pyrrolidone (NVP), 12 parts by weight of methyl methacrylate (MMA) and 13 parts by weight of 2-hydroxyethyl acrylate (HEA) as monomer components, 0.2 parts by weight of 2,2′-azobisisobutyronitrile (AIBN) as a polymerization initiator, and 122 parts by weight of ethyl acetate and 40.7 parts by weight of toluene as a polymerization solvent were put into a separable flask, followed by stirring for 1 hour while nitrogen gas was introduced. After oxygen in the polymerization system was removed thereby, the system was heated to 65° C., followed by reacting for 10 hours, and thereafter, ethyl acetate was added thereto to obtain an acrylic polymer solution having a solid concentration of 36 wt %.

A pressure-sensitive adhesive composition (solution) was prepared by adding 0.3 parts by weight of an isocyanate-based crosslinking agent (manufactured by Mitsui Chemicals, Inc., trade name “TAKENATE D110N”) as a crosslinking agent thereto based on 100 parts by weight of the acrylic polymer in the acrylic polymer solution, and mixing them.

Subsequently, a pressure-sensitive adhesive sheet (substrateless double-sided pressure-sensitive adhesive sheet) was obtained in the same manner as in Example 1 from the pressure-sensitive adhesive composition (solution).

### Example 4

52 parts by weight of 2-ethylhexyl acrylate (2EHA), 20 parts by weight of N-vinyl-2-pyrrolidone (NVP), 15 parts by weight of methyl methacrylate (MMA) and 13 parts by weight of 2-hydroxyethyl acrylate (HEA) as monomer components, 0.2 parts by weight of 2,2′-azobisisobutyronitrile (AIBN) as a polymerization initiator, and 122 parts by weight of ethyl acetate and 40.7 parts by weight of toluene as a polymerization solvent were put into a separable flask, followed by stirring for 1 hour while nitrogen gas was introduced. After oxygen in the polymerization system was removed thereby, the system was heated to 65° C., followed by reacting for 10 hours, and thereafter, ethyl acetate was added thereto to obtain an acrylic polymer solution having a solid concentration of 36 wt %.

A pressure-sensitive adhesive composition (solution) was prepared by adding 0.3 parts by weight of an isocyanate-based crosslinking agent (manufactured by Mitsui Chemicals, Inc., trade name “TAKENATE D110N”) as a crosslinking agent thereto based on 100 parts by weight of the acrylic polymer in the acrylic polymer solution, and mixing them.

Subsequently, a pressure-sensitive adhesive sheet (substrateless double-sided pressure-sensitive adhesive sheet) was obtained in the same manner as in Example 1 from the pressure-sensitive adhesive composition (solution).

### Comparative Example 1

42 parts by weight of butyl acrylate (BA), 13 parts by weight of ethyl acrylate (EA), 15 parts by weight of methyl methacrylate (MMA) and 30 parts by weight of 4-hydroxybutyl acrylate (4HBA) as monomer components, 0.2 parts by weight of 2,2′-azobisisobutyronitrile (AIBN) as a polymerization initiator, and 70 parts by weight of ethyl acetate and 75 parts by weight of toluene as a polymerization solvent were put into a separable flask, followed by stirring for 1 hour while nitrogen gas was introduced. After oxygen in the polymerization system was removed thereby, the system was heated to 65° C., followed by reacting for 10 hours, and thereafter, ethyl acetate was added thereto to obtain an acrylic polymer solution having a solid concentration of 36 wt %.

A pressure-sensitive adhesive composition (solution) was prepared by adding 0.3 parts by weight of an isocyanate-based crosslinking agent (manufactured by Mitsui Chemicals, Inc., trade name “TAKENATE D110N”) as a crosslinking agent thereto based on 100 parts by weight of the acrylic polymer in the acrylic polymer solution, and mixing them.

Subsequently, a pressure-sensitive adhesive sheet (substrateless double-sided pressure-sensitive adhesive sheet) was obtained in the same manner as in Example 1 from the pressure-sensitive adhesive composition (solution).

### Comparative Example 2

27 parts by weight of 2-ethylhexyl acrylate (2EHA), 23 parts by weight of ethyl acrylate (EA), 15 parts by weight of methyl methacrylate (MMA) and 35 parts by weight of 4-hydroxybutyl acrylate (4HBA) as monomer components, 0.2 parts by weight of 2,2′-azobisisobutyronitrile (AIBN) as a polymerization initiator, and 70 parts by weight of ethyl acetate and 75 parts by weight of toluene as a polymerization solvent were put into a separable flask, followed by stirring for 1 hour while nitrogen gas was introduced. After oxygen in the polymerization system was removed thereby, the system was heated to 65° C., followed by reacting for 10 hours, and thereafter, ethyl acetate was added thereto to obtain an acrylic polymer solution having a solid concentration of 36 wt %.

A pressure-sensitive adhesive composition (solution) was prepared by adding 0.3 parts by weight of an isocyanate-based crosslinking agent (manufactured by Mitsui Chemicals, Inc., trade name “TAKENATE D110N”) as a crosslinking agent thereto based on 100 parts by weight of the acrylic polymer in the acrylic polymer solution, and mixing them.

Subsequently, a pressure-sensitive adhesive sheet (substrateless double-sided pressure-sensitive adhesive sheet) was obtained in the same manner as in Example 1 from the pressure-sensitive adhesive composition (solution).

### Comparative Example 3

45 parts by weight of butyl acrylate (BA), 15 parts by weight of ethyl acrylate (EA), 15 parts by weight of methyl methacrylate (MMA) and 25 parts by weight of 4-hydroxybutyl acrylate (4HBA) as monomer components, 0.2 parts by weight of 2,2′-azobisisobutyronitrile (AIBN) as a polymerization initiator, and 95 parts by weight of ethyl acetate and 50 parts by weight of toluene as a polymerization solvent were put into a separable flask, followed by stirring for 1 hour while nitrogen gas was introduced. After oxygen in the polymerization system was removed thereby, the system was heated to 65° C., followed by reacting for 10 hours, and thereafter, ethyl acetate was added thereto to obtain an acrylic polymer solution having a solid concentration of 36 wt %.

A pressure-sensitive adhesive composition (solution) was prepared by adding 0.3 parts by weight of an isocyanate-based crosslinking agent (manufactured by Mitsui Chemicals, Inc., trade name “TAKENATE D110N”) as a crosslinking agent thereto based on 100 parts by weight of the acrylic polymer in the acrylic polymer solution, and mixing them.

Subsequently, a pressure-sensitive adhesive sheet (substrateless double-sided pressure-sensitive adhesive sheet) was obtained in the same manner as in Example 1 from the pressure-sensitive adhesive composition (solution).

### Comparative Example 4

67 parts by weight of butyl acrylate (BA), 14 parts by weight of cyclohexyl acrylate (CHA), 27 parts by weight of 4-hydroxybutyl acrylate (4HBA), 9 parts by weight of 2-hydroxyethyl acrylate (HEA), 0.05 parts by weight of 2,2-dimethoxy-1,2-diphenyl-1-one (trade name “IRGACURE 651”, manufactured by BASF Japan Co., Ltd.) and 0.05 parts by weight of 1-hydroxy-cyclohexyl-phenyl-ketone (trade name “IRGACURE 184”, manufactured by BASF Japan Co., Ltd.) were put into a four-neck flask, followed by partially photopolymerizing by exposing the mixture to UV under nitrogen atmosphere to obtain a partially polymerized product (monomer syrup) having a polymerization ratio of 10%.

0.1 parts by weight of an isocyanate compound (trade name “CORONATE L”, manufactured by NIPPON POLYURETHANE INDUSTRY CO., LTD., solid content 75 wt %) in terms of the solid content were added to 100 parts by weight of the partially polymerized product, and then, they were uniformly mixed to obtain a photopolymerizable composition.

This photopolymerizable composition was applied on a release-treated surface of a release liner (separator) (trade name “MRF38”, manufactured by Mitsubishi Plastics Inc., a type in which one side of a polyethylene terephthalate film was release-treated, thickness of 38 μm) to form an coat layer, and then, the same release liner was formed on the coat layer.

Subsequently, a pressure-sensitive adhesive sheet (substrateless double-sided pressure-sensitive adhesive sheet, thickness of the pressure-sensitive adhesive layer: 175 μm) was manufactured by irradiating UV having an intensity of 5 mW/cm² by black light and performing polymerization until the intensity of light became 3600 mJ/cm².

The following measurements or evaluations were performed with respect to the pressure-sensitive adhesive sheets obtained in the Examples and Comparative Examples. The results are shown in Table 1.

(1) Relative Dielectric Constant

The relative dielectric constant of the pressure-sensitive adhesive layer at a frequency of 100 kHz was measured under the following conditions in accordance with JIS K 6911.

Measurement method: Volumetric method (Device: Agilent Technologies 4294A Precision Impedance Analyzer)

Electrode constitution: Aluminum plate having a diameter of 12.1 mm and a thickness of 0.5 mm

Counter electrode: 3 oz copper plate

Measurement environment: 23±1° C., 52±1% RH

(2) Moisture Ratio

The double-sided pressure-sensitive adhesive sheet obtained in the Examples and Comparative Examples was cut into a size of width 1 cm×length 2 cm (area: 2 cm²). Subsequently, the release liner was peeled therefrom, and an aluminum foil was laminated to one pressure-sensitive adhesive surface, while the other pressure-sensitive adhesive surface was in the exposed state, to prepare a sample (having a layer structure of “pressure-sensitive adhesive layer/aluminum foil”). The weight of the aluminum foil laminated to the sample was measured in advance before the foil was laminated to the pressure-sensitive adhesive sheet.

The sample was put in a thermo-hygrostat in which the internal condition of the chamber was controlled to 60° C. and 95% RH, followed by storing for 120 hours. Thereafter, the sample was taken from the thermo-hygrostat, and the weight of the sample was measured. Subsequently, the sample was put in the following heating vaporization apparatus, and a gas generated by heating at 150° C. for 10 min was introduced into a titration cell of the following coulometric titration moisture measuring apparatus, and then the moisture content (μg) of the gas was measured to measure the moisture content (μg) of the pressure-sensitive adhesive layer after storage under the environment of 60° C. and 95% RH for 120 hours. The moisture ratio (wt %) of the pressure-sensitive adhesive layer after storage under the environment of 60° C. and 95% RH for 120 hours was calculated by using the following equation. The average value was calculated by setting the number of measurements (n number) twice.

“Moisture ratio of the pressure-sensitive adhesive layer (wt %)”=“moisture content (μg) of the pressure-sensitive adhesive layer after storage under the environment of 60° C. and 95% RH for 120 hours”/(“weight (μg) of the sample after storage under the environment of 60° C. and 95% RH for 120 hours”−“weight (μg) of the aluminum foil”)×100

(Analysis Apparatus)

Coulometric titration moisture measuring apparatus: “CA-06 type” manufactured by Mitsubishi Chemical Corp.

Heating vaporization apparatus: “VA-06 type” manufactured by Mitsubishi Chemical Corp.

(Measuring Conditions)

Method: heating vaporization method/150° C. heating

Anode solution: Aquamicron AKX

Cathode solution: Aquamicron CXU

(3) Total Light Transmittance and Haze

The release liner of the double-sided pressure-sensitive adhesive sheet obtained in the Examples and Comparative Examples was peeled, and a glass plate (slide glass, lot No. “S-1111”, Matsunami Glass Ind., Ltd., thickness of 1.3 mm, haze of 0.1%, and ground edges) was laminated to one pressure-sensitive adhesive surface, while the other pressure-sensitive adhesive surface was in the exposed state, to prepare a sample (having a layer structure of “pressure-sensitive adhesive layer/glass plate”).

With respect to the sample, the total light transmittance and haze were measured by a haze meter (device name “HM-150” manufactured by Murakami Color Research Laboratory Co., Ltd.). The haze (%) was also obtained by an equation of “diffusion transmittance/total light transmittance×100”.

(4) Amount of the Extracted (Meth)Acrylic Acid Ion

A PET film (manufactured by Toray Industries Inc., “LUMIRROR S10”, thickness of 25 μm) was laminated to the pressure-sensitive adhesive surface of one side of the double-sided pressure-sensitive adhesive sheet obtained in the Examples and Comparative Examples, followed by cutting into sheet pieces having a size of width 10 cm×length 10 cm. Thereafter, the release liner was peeled to prepare a sample in which the pressure-sensitive adhesive surface of only one side thereof was exposed (exposure area of the pressure-sensitive adhesive surface: 100 cm²).

Subsequently, the sample was put in pure water (50 ml) at a temperature of 100° C., followed by boiling for 45 min and performing boiling extraction to obtain an extraction solution.

Subsequently, the total amount (unit: ng) of the acrylic acid ion and methacrylic acid ion in the obtained extraction solution was measured by using the ion chromatograph method (ion chromatography), and the total amount (amount of extracted (meth)acrylic acid ion, unit: ng/cm²) of the acrylic acid ion and methacrylic acid ion per unit area of the pressure-sensitive adhesive surface (exposed pressure-sensitive adhesive surface) of the sample was calculated. The case when the amount of the extracted (meth)acrylic acid ion was less than the detection limit (detection limit: 2.5 ng) was described as “ND” in Table 1.

[Measuring Condition of Ion Chromatograph Method]

Analysis apparatus: DX-320, manufactured by DIONEX Co., Ltd.

Separation column: Ion Pac AS15 (4 mm×250 mm)

Guard column: Ion Pac AG15 (4 mm×50 mm)

Removal system: ASRS-ULTRA (External mode, 100 mA)

Detector: Electric conductivity detector

Eluent: 7 mM KOH (0 min to 20 min)
45 mM KOH (20 min to 30 min)
(eluent generator EG40 was used)

Flow rate of eluent: 1.0 ml/min

Injection amount of sample: 250 μl

(5) Humidified Turbidity (Presence/Absence of White Turbidity Due to Humidification)

The release liner was peeled from the double-sided pressure-sensitive adhesive sheet obtained in the Examples and Comparative Examples, and the pressure-sensitive adhesive surface of one side of the double-sided pressure-sensitive adhesive sheet was laminated to a glass plate (slide glass, lot No. “S-1111”, MATSUNAMI GLASS IND., LTD., thickness of 1.3 mm, haze of 0.1%, and ground edges), and the pressure-sensitive adhesive surface of the other side thereof was laminated to an ITO film-formed surface of a conductive PET film (trade name “ELECRYSTA V270L-THMP”, manufactured by Nitto Denko Corp.) to prepare a sample having a layer structure of “slide glass/double-sided pressure-sensitive adhesive sheet (pressure-sensitive adhesive layer)/conductive PET film”. The haze of the sample was measured under the environment of 23° C. and 50% RH by using a haze meter (trade name “HM-150”, manufactured by MURAKAMI Color Research Laboratory), and the obtained haze data was used as the “initial haze”.

Subsequently, the sample was stored under the environment of 60° C. and 95% RH (under the hygrothermal environment) for 120 hours. Thereafter, the sample was taken therefrom under the environment of 23° C. and 50% RH, and the following hazes were measured: the haze immediately after the sample was taken therefrom (referred to as “haze (immediately after)”); the haze after the passage of 30 minutes since the sample was taken therefrom under the environment of 23° C. and 50% RH (referred to as “haze (after 30 min)”); the haze after the passage of 1 hour since the sample was taken therefrom under the environment of 23° C. and 50% RH (referred to as “haze (after 1 hour)”); and the haze after the passage of 2 hours since the sample was taken therefrom under the environment of 23° C. and 50% RH (referred to as “haze “after 2 hours)”). An increase width of the “haze (immediately after)” to the “initial haze” [=(haze (immediately after))−(initial haze)], an increase width of the “haze (after 30 min)” to the “initial haze” [=(haze (after 30 min))−(initial haze)], an increase width of the “haze (after 1 hour)” to the “initial haze” [=(haze (after 1 hour))−(initial haze)], and an increase width of the “haze (after 2 hours)” to the “initial haze” [=(haze (after 2 hours))−(initial haze)] were calculated, respectively, and the case where all was less than 5.0% (% point) was evaluated as “A” (there was no white turbidity caused by humidification), and the case where any one was 5.0% or more (% point) was evaluated as “B” (there was white turbidity caused by humidification). The results are shown in the column of “Humidified turbidity” in Table 1.

(6) Corrosion Resistance (Change in ITO Resistance Value)

A PET film (manufactured by Toray Industries Inc., trade name “LUMIRROR S-10 #25”, and thickness of 25 μm) was laminated to the pressure-sensitive adhesive surface of one side of the double-sided pressure-sensitive adhesive sheet obtained in the Examples and Comparative Examples, followed by cutting into sheet pieces having a size of width 20 mm×length 50 mm, to be used as a sample.

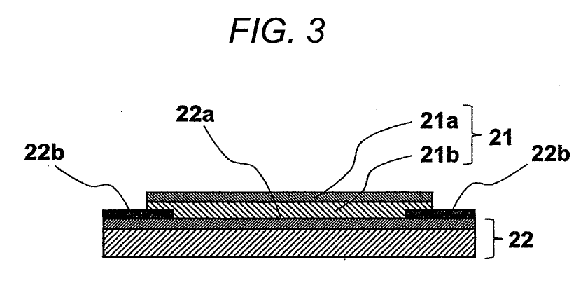

As shown in FIGS. 2 and 3, a silver paste was coated on both ends of a conductive PET film 22 (manufactured by Nitto Denko Corp., trade name “ELECRYSTA P-400 LTNMP”) (size: length 70 mm×width 25 mm) in the width of 15 mm, followed by laminating the pressure-sensitive adhesive surface of the sample 21, from which the release liner was peeled, to the conductive surface thereof (ITO film-formed surface 22a side) to prepare a laminate (laminate of the sample 21 and the conductive PET film 22) (sample for resistance measurement). After the laminate was left standing for 24 hours under the environment of 23° C., it was left standing for 250 hours under each of the environment of 60° C. and 95% RH and the environment of 80° C., and then, the ratio (%) of the “resistance value after the laminate was left standing at 60° C. and 95% RH for 250 hours” to the “resistance value immediately after the lamination” [=(resistance value after the laminate was left standing at 60° C. and 95% RH for 250 hours)/(resistance value immediately after the lamination)×100(%)], and the ratio (%) of the “resistance value after the laminate was left standing at 80° C. for 250 hours” to the “resistance value immediately after the lamination” [=(resistance value after the laminate was left standing at 80° C. for 250 hours)/(resistance value immediately after the lamination)×100(%)] were measured, respectively. The resistance value was measured by attaching electrodes to the silver paste coated parts 22b of both ends of the laminate by using a “3540 Miliohm Hightester” manufactured by Hioki Electric Co., Ltd.

If both of the ratio of the “resistance value after the laminate was left standing at 60° C. and 95% RH for 250 hours” to the “resistance value immediately after the lamination” and the ratio of the “resistance value after the laminate was left standing at 80° C. for 250 hours” to the “resistance value immediately after the attachment” were less than 120%, the corrosion resistance was evaluated as “good”, and if any one of the ratios was 120% or more, the corrosion resistance was evaluated as “faulty”. The results are shown in the column of “Corrosion resistance” in Table 1.

The same test was performed by using only the conductive PET film to which the pressure-sensitive adhesive sheet was not laminated, as the blank, and as a result, the ratios of the “resistance value after the laminate was left standing for 250 hours” to the “resistance value before the laminate was left standing for 250 hours” were 110% at 80° C. and 120% at 60° C. and 95% RH, respectively.

TABLE 1

| | | Relative | | | | | | |
|---|---|---|---|---|---|---|---|---|
| | | dielectric | Moisture | Total light | | Amount of extracted | | |
| | Monomer composition | constant | ratio | transmittance | Haze | (meth)acrylic acid ion | Humidified | Corrosion |
| | [parts by weight] | (frequency: 100 kHz) | [wt %] | [%] | [%] | [ng/cm²] | turbidity | resistance |
| Example 1 | 2EHA/NVP/MMA/HEA = | 3.7 | 2.2 | 92.0 | 0.4 | ND | A | Good |
| | 46/15/18/21 | | | | | | | |
| Example 2 | 2EHA/NVP/MMA/HEA = | 2.8 | 2.1 | 92.0 | 0.4 | ND | A | Good |
| | 46/15/24/21 | | | | | | | |
| Example 3 | 2EHA/NVP/MMA/HEA = | 3.0 | 1.3 | 92.0 | 0.4 | ND | A | Good |
| | 55/20/12/13 | | | | | | | |
| Example 4 | 2EHA/NVP/MMA/HEA = | 3.1 | 1.3 | 92.0 | 0.4 | ND | A | Good |
| | 52/20/15/13 | | | | | | | |
| Comparative | BA/EA/MMA/4HBA = | 4.9 | 2.5 | 92.0 | 0.4 | ND | A | Good |
| Example 1 | 42/13/15/30 | | | | | | | |
| Comparative | 2EHA/EA/MMA/4HBA = | 4.4 | 3.0 | 92.0 | 0.4 | ND | A | Good |
| Example 2 | 27/23/15/35 | | | | | | | |
| Comparative | BA/EA/MMA/4HBA = | 4.6 | 2.5 | 92.0 | 0.4 | ND | A | Good |
| Example 3 | 45/15/15/25 | | | | | | | |
| Comparative | BA/CHA/4HBA/HEA = | 7.1 | 3.0 | 92.0 | 0.4 | ND | A | Good |
| Example 4 | 67/14/27/9 | | | | | | | |

While the invention has been described in detail and with reference to specific embodiments thereof, it will be apparent to one skilled in the art that various changes and modifications can be made therein without departing from the spirit and scope thereof.

This application is based on Japanese Patent Application No. 2011-032493 filed on Feb. 17, 2011, and the entire subject matter of which is incorporated herein by reference.

The present invention provides the following optical pressure-sensitive adhesive sheet.

(1) An optical pressure-sensitive adhesive sheet, comprising:

a pressure-sensitive adhesive layer in which a relative dielectric constant at a frequency of 100 kHz is 4 or less, and a moisture ratio after storage under an environment of 60° C. and 95% RH for 120 hours is 0.65 wt % or more.

(2) The optical pressure-sensitive adhesive sheet according to (1), which has a total light transmittance of 90% or more and a haze of 3% or less.

(3) The optical pressure-sensitive adhesive sheet according to (1) or (2), wherein the pressure-sensitive adhesive layer comprises an acrylic polymer comprising, as a monomer component, at least one monomer selected from the group consisting of alkyl ester acrylate having a linear or branched alkyl group having 6 to 10 carbon atoms, alkyl ester methacrylate having a linear or branched alkyl group having 1 to 10 carbon atoms, ester (meth)acrylate having an alicyclic hydrocarbon group and a nitrogen-containing monomer, in which a ratio of the monomer component is 60 wt % or more based on a total amount (100 wt %) of monomer components constituting the acrylic polymer.

(4) The optical pressure-sensitive adhesive sheet according to (3), wherein the ester (meth)acrylate having an alicyclic hydrocarbon group is at least one monomer selected from the group consisting of cyclohexyl (meth)acrylate and isobornyl (meth)acrylate.

(5) The optical pressure-sensitive adhesive sheet according to (3) or (4), wherein the nitrogen-containing monomer is at least one monomer selected from the group consisting of (meth)acryloyl morpholine and N-vinylpyrrolidone.

(6) The optical pressure-sensitive adhesive sheet according to any one of (1) to (5), wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

(7) An optical pressure-sensitive adhesive sheet comprising:

a pressure-sensitive adhesive layer in which a relative dielectric constant at a frequency of 100 kHz is 4 or less, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

### DESCRIPTION OF REFERENCE NUMERALS AND SIGNS

1: Electric capacity type touch panel
11: Decorative panel
12: Optical pressure-sensitive adhesive sheet
13: ITO film
14: Hard coat film
21: Sample
21a: PET film
21b: Pressure-sensitive adhesive sheet (double-sided pressure-sensitive adhesive sheet)
22: Conductive PET film
22a: ITO-film formed surface of conductive PET film
22b: Silver paste coated part of conductive PET film

What is claimed is:

1. An optical pressure-sensitive adhesive sheet, comprising:
a pressure-sensitive adhesive layer in which a relative dielectric constant at a frequency of 100 kHz is 4 or less, and a moisture ratio after storage under an environment of 60° C. and 95% RH for 120 hours is 0.65 wt % or more.

2. The optical pressure-sensitive adhesive sheet according to claim 1, which has a total light transmittance of 90% or more and a haze of 3% or less.

3. The optical pressure-sensitive adhesive sheet according to claim 1, wherein the pressure-sensitive adhesive layer comprises an acrylic polymer comprising, as a monomer component, at least one monomer selected from the group consisting of alkyl ester acrylate having a linear or branched alkyl group having 6 to 10 carbon atoms, alkyl ester methacrylate having a linear or branched alkyl group having 1 to 10 carbon atoms, ester (meth)acrylate having an alicyclic hydrocarbon group and a nitrogen-containing monomer, in which a ratio of the monomer component is 60 wt % or more based on a total amount (100 wt %) of monomer components constituting the acrylic polymer.

4. The optical pressure-sensitive adhesive sheet according to claim 3, wherein the ester (meth)acrylate having an alicyclic hydrocarbon group is at least one monomer selected from the group consisting of cyclohexyl (meth)acrylate and isobornyl (meth)acrylate.

5. The optical pressure-sensitive adhesive sheet according to claim 3, wherein the nitrogen-containing monomer is at least one monomer selected from the group consisting of (meth)acryloyl morpholine and N-vinylpyrrolidone.

6. The optical pressure-sensitive adhesive sheet according to claim 1, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

7. An optical pressure-sensitive adhesive sheet comprising:
a pressure-sensitive adhesive layer in which a relative dielectric constant at a frequency of 100 kHz is 4 or less, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

8. The optical pressure-sensitive adhesive sheet according to claim 2, wherein the pressure-sensitive adhesive layer comprises an acrylic polymer comprising, as a monomer component, at least one monomer selected from the group consisting of alkyl ester acrylate having a linear or branched alkyl group having 6 to 10 carbon atoms, alkyl ester methacrylate having a linear or branched alkyl group having 1 to 10 carbon atoms, ester (meth)acrylate having an alicyclic hydrocarbon group and a nitrogen-containing monomer, in which a ratio of the monomer component is 60 wt % or more based on a total amount (100 wt %) of monomer components constituting the acrylic polymer.

9. The optical pressure-sensitive adhesive sheet according to claim 8, wherein the ester (meth)acrylate having an alicyclic hydrocarbon group is at least one monomer selected from the group consisting of cyclohexyl (meth)acrylate and isobornyl (meth)acrylate.

10. The optical pressure-sensitive adhesive sheet according to claim 8, wherein the nitrogen-containing monomer is at least one monomer selected from the group consisting of (meth)acryloyl morpholine and N-vinylpyrrolidone.

11. The optical pressure-sensitive adhesive sheet according to claim 4, wherein the nitrogen-containing monomer is at least one monomer selected from the group consisting of (meth)acryloyl morpholine and N-vinylpyrrolidone.

12. The optical pressure-sensitive adhesive sheet according to claim 9, wherein the nitrogen-containing monomer is at least one monomer selected from the group consisting of (meth)acryloyl morpholine and N-vinylpyrrolidone.

13. The optical pressure-sensitive adhesive sheet according to claim 2, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

14. The optical pressure-sensitive adhesive sheet according to claim 3, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

15. The optical pressure-sensitive adhesive sheet according to claim 8, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

16. The optical pressure-sensitive adhesive sheet according to claim 4, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

17. The optical pressure-sensitive adhesive sheet according to claim 9, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

18. The optical pressure-sensitive adhesive sheet according to claim 5, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

19. The optical pressure-sensitive adhesive sheet according to claim 10, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.

20. The optical pressure-sensitive adhesive sheet according to claim 11, wherein a total amount of an acrylic acid ion and methacrylic acid ion which are extracted with pure water under a condition of 100° C. and 45 min, which is measured by an ion chromatograph method, is 300 ng/cm² or less per unit area of the pressure-sensitive adhesive layer.
